(19) United States
(12) Patent Application Publication
(10) Pub. No.: US 2012/0203733 A1
(43) Pub. Date: Aug. 9, 2012

(54) Method and system for personal cloud engine

(76) Inventor: Amy H. Zhang, San Mateo, CA (US)

(21) Appl. No.: 12/931,750

(22) Filed: Feb. 9, 2011

(51) Int. Cl. G06F 17/30

(52) U.S. Cl. 707/600; 707/E17.108

(57) ABSTRACT

Personal Cloud Engine (iCloud) described in the present invention collects information relevant to a user from various data sources including personal email accounts, social network accounts, online vendors, on-line services for store and share photos and videos and on-line bank accounts. Collected data are classified, indexed, tagged and stored in a persistent data storage device. Web interface such as HTTP is provides for access data by a client, which can be web browser running on a computing device or a client application running on a smart phone. By gathering all the data, iCloud maintains a secondary copy of all valuable personal data and effectively prevents data loss. iCloud can also utilize the data and extract intrinsic value from the data stored by data mining and analytic tools.

### TECHNICAL FIELD

The disclosed embodiments relate generally to data collection, processing and management, and more particularly, to gathering personal data from internet for centralized management.

### BACKGROUND

Today's society is experiencing unprecedented growth in the number and variety of data generation as computer technology, network connectivity and disk storage space becomes increasingly affordable. As information technology becomes ever more prevalent in nearly every aspect of our lives, the amount of data generated and stored continues to grow at an astounding rate. According to International Business Machine Corporation (IBM), worldwide data volumes are currently doubling every two years. The burgeoning amount of user-generated content, which has increased 15-fold over the past few years, is due to several reasons. The emerging of social network in recent years results generating almost incomprehensible amount of data on web about all of us, much of which we have generated ourselves, such as blogs, photos and videos. With many corporations offering free/low cost email service with Gigs of storage space, it is not unusual that an individual may own multiple email accounts. The recent success of e-commence and computerizing traditional business operations further fumed the data proliferation.

Personal data exploration we are experiencing today creates a great deal of challenges on how to manage data efficiently in many aspects. First, the massive amount of data about an individual is distributed among numerous locations, which are geo-graphically separated. With volume of gigabytes sometimes terabyte of personal data scattered around many storage devices at home, office and internet service providers (public cloud), data becomes unorganized and sometimes obsolete. Therefore, it is very hard for users, the owner of the personal data or his/her friends, to find or filter data that is interested and relevant. Secondary, with introducing of heterogynous client devices ranging from laptop, desktop, hand held computing device and smart phones, the access of data become more complicated as each data repository in different organization has different data access mechanism. Furthermore, for an online service provider, personal data for all users are stored in shared storage devices for all users, Furthermore, as data is managed by multiple online service providers, high availability and no data loss of one's personal data become very challenge. Within one service provider, physically stored in shared storage devices for all users, data security also become an increasing concern.

There are several ongoing efforts on data aggregation to collect personal data in a specific aspect. For example, www.mint.com collects and manages all financial data from various sources for an individual. However, such efforts still follow the same pattern of providing service from the public cloud, the internet. There is no solution aggregates personal data in ALL aspects and stored in personal storage devices in a private location. The presented invention to provide a mechanism which can manage personal data efficiently and reliably as well as utilizes data intelligently to help users improving their daily commercial and social activities.

### SUMMARY

Personal Cloud Engine (iCloud) described in the present invention collects information about a user from various data sources including personal email accounts, social network accounts, e-commence accounts, on-line content (photos and videos) sharing accounts and on-line bank accounts. Collected data are classified, indexed and tagged before the data is stored in a private persistent data storage. Web interface such as HTTP is provides for access data by a client device, which can be web browser running on a computing device or a client application running on a smart phone.

It is an objective of the present invention to collect and store high value and important personal data for the user in a centralized and secured location. As personal data are scattered over multiple physical locations and owned by different organizations, the availability of the data is depends on the reliability of each storage facility. Recently, several incidents occurred related to the data loss and legal liability when data is disorganized, not properly replicated, or cannot be found in a timely manner. By gathering all the data, iCloud maintains a secondary copy of all valuable personal data and effectively prevents data loss. Furthermore, iCloud can greatly improve high availability of data, as all personal data is still accessible even when an organization's storage or access facility is experiencing downtime due to outage or maintenance.

It is another objective of the present invention to provide single access point to access all personal data in an easy and efficient way. Personal data includes emails, posts and blogs on social network websites, photos and videos on online content sharing websites, online shopping transactions and online banks accounts. To access those data, a user is required to login in multiple on-line accounts with user name and password. Moreover, for accessing the data stored in personal computing devices, such as laptop, desktop and smart phone, physical access of the device is necessary. With single login to iCloud, a user can access the data from a client device with no constrains of physical locations. iCloud also provides a central access point for the content that a user wants to share with his/her friends.

It is a further object of the present invention to utilize the data and extract intrinsic value from the data stored in iCloud by data mining and analytic tools. For example, by analyzing all personal shopping transactions and experience from all online vendors, a consumer profile can be generated. The consumer profile may be submitted to online vendors, which can produce and send a customized advisement to user. Other profiles such as personal preference of sports and entertainment can be also shared with connected friends.

It is yet an additional object of the present invention to provide an automatic way of acquiring real time information that a user is interested in. With the capability of web crawling, iCloud can visit websites over internet periodically, once the content that meet the pre-defined criteria is found, the information would be downloaded and a notification will be sent to the user. For example, iCloud can be configured to find the best deal for some products from e-commerce websites such as e-Bay and Amazon. iCloud can also looking for the airline tickets and accommodations from on-line reservation websites.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates the personal cloud system and its interaction with the public internet cloud, local devices and client devices.

FIG. 2 illustrates the personal cloud system internal structure and major modules and their functionalities are shown.

FIG. 3 illustrates the data acquisition and synchronization flow controlled by periodic schedule or manual user input. The data acquisition can be implemented specialized search engine for personal data.

FIG. 4A shows a mockup screen of graphical user interface (GUI) for user to access data and manage iCloud from a client device.

FIG. 4B illustrates an alternative perspective in which the personal data can be viewed by the user.

FIG. 5A and FIG. 5G are a screen mockups where the user can add a data source.

### DETAILED DESCRIPTION

Reference will now be made in detail to some embodiments of the invention, examples of which are illustrated in the accompanying drawings. Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims. While the claimed subject matter will be described in conjunction with these embodiments for illustration purposes, it will be understood that they are not intended to limit the claimed subject matter to these embodiments. On the contrary, the claimed subject matter is intended to cover alternatives, modifications and equivalents, which can be included within the spirit and scope of the claimed subject matter as defined by the appended claims. Furthermore, in the following detailed description of the present claimed subject matter, numerous specific details are set forth in order to provide a thorough understanding of the present claimed subject matter. However, it will be evident to one of ordinary skill in the art that the present claimed subject matter could be practiced without these specific details.

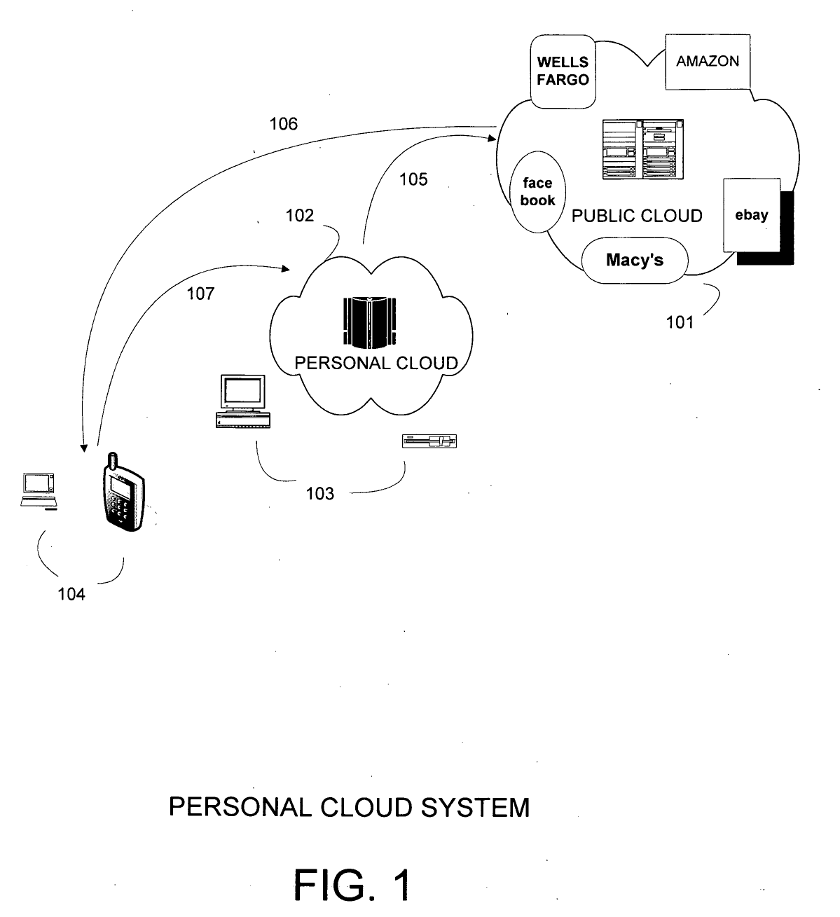

FIG. 1 shows how a Personal Cloud Engine (iCloud) fit in current internet based information networks. There are numerous commercial and non-commercial organizations providing on-line services over the internet. Free or minimum cost online services include emails such as yahoo mail, gmail and hotmail, social networking such as Facebook and Twitter, e-commence such as Amazon, eBay and BestBuy, on-line content sharing such as Flikr, and on-line personal service such as Mint. As result of using these on-line services, a user's related personal data are retained on the storage devices owned by the organizations which provide the services. All these on-line services form a public cloud 101 and an individual's personal information is scattered in the public cloud. iCloud 102 creates a “personal cloud” by cheer picking all the data a user interested in from the public cloud 101 through connection 105. As a result, a centralized second copy of all personal data related to the user is generated for personal accessing and sharing among other trusted user groups. iCloud is also capable of synchronizing data from user's other computing devices or storage devices 103 when the devices are directly connected to iCloud. To access data from iCloud, user can connect to iCloud via local area network (LAN) connection 107 using a client device, such as smart phone, laptop and tablet. When user is located remotely, the client device can access iCloud through internet connection 106 and 105.

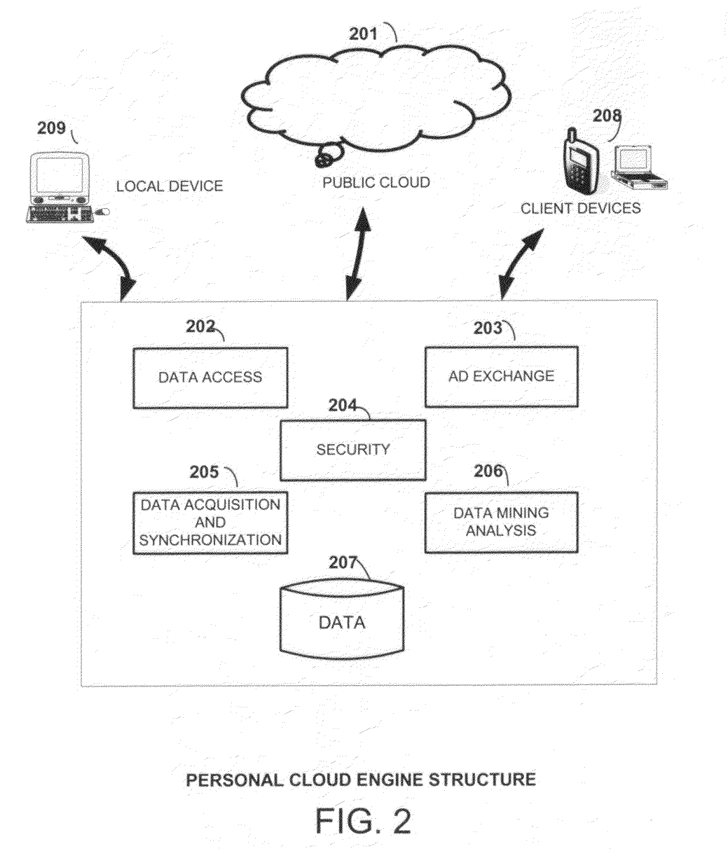

FIG. 2 illustrates the internal structure of iCloud with major internal modules. Security module 204 is responsible for the data security including accessing and transportation. When iCloud receives a login request from client devices, it requests client devices to provide user credential, typically user name and password, before permitting the login. Then data access requests are processed according to the access control rules and permissions stored in the iCloud and the access request is either granted or denied. Security module 204 also performs encryption and decryption for data transportation. Data acquisition and synchronization module 205 visits a pre-specified websites (data sources) over the internet, logins in with user's credential and downloads relevant data. The data acquisition module also include the features such as scheduling, iterating over multiple URLs, downloading meta data and contents, indexing and tagging downloaded data and storing data in data repository 207. The detail flow of data acquisition is presented in later sections. Data access module 202 processes data access requests from client devices, retrieves data from data storage 207. The response data are formatted before sent to client devices depends on the type of software, such as web browser, tablet or smart phone client applications, running on the client devices.

Data mining and analysis module 206 is responsible for searching and analyzing, data in the repository 207 and extracting useful information to generate profile data conforming a data model. A data model can be described by a set of attributes and a profile data conforming a data model provides values for each of the attribute. For example, a consumer data model contains preferred brands, merchandise categories interested and the price range as attributes. Based on all the transactions the user made over online shopping from a particular e-commence vendor or all vendors, the consumer profile data of the user can be generated. The consumer profile can be used for personal reviewing and sharing with friends or it can be submitted to the on-line vendors so that the vendor can provide better services to the user in an individual base. In another embodiment, iCloud brings consumer profile such as user's multi-level geographic location (street, community, zip code, city and state), shopping habits, routines, favor goods and price-targets to the ecommerce space. Such profile builds a ‘guided shopping platform’ that enables connections between potential customers of online shopping sites and product experts they can talk to before making a purchase decision. At same time, e-commerce vendors can adjust their goods, inventory and promotion to meet the shopper's needs at optimized cost.

Advisement exchange module 203 intelligently downloads relevant advisements from e-commence vendors based on the user profile data produced by data mining and analysis module 206. Since iCloud provides an open software platform, applications developed by third party can be downloaded and installed on iCloud. It is possible that an application developed by an online-service provider can be installed on iCloud to address particular requirements of the service provider. For example, an third party application can retrieve commercial advisements from e-commerce sites based on user's consumer profile data. Comparing to today's advisements which mostly are generic for targeting all consumers, this is a much effective way to build relationship between consumers and vendors.

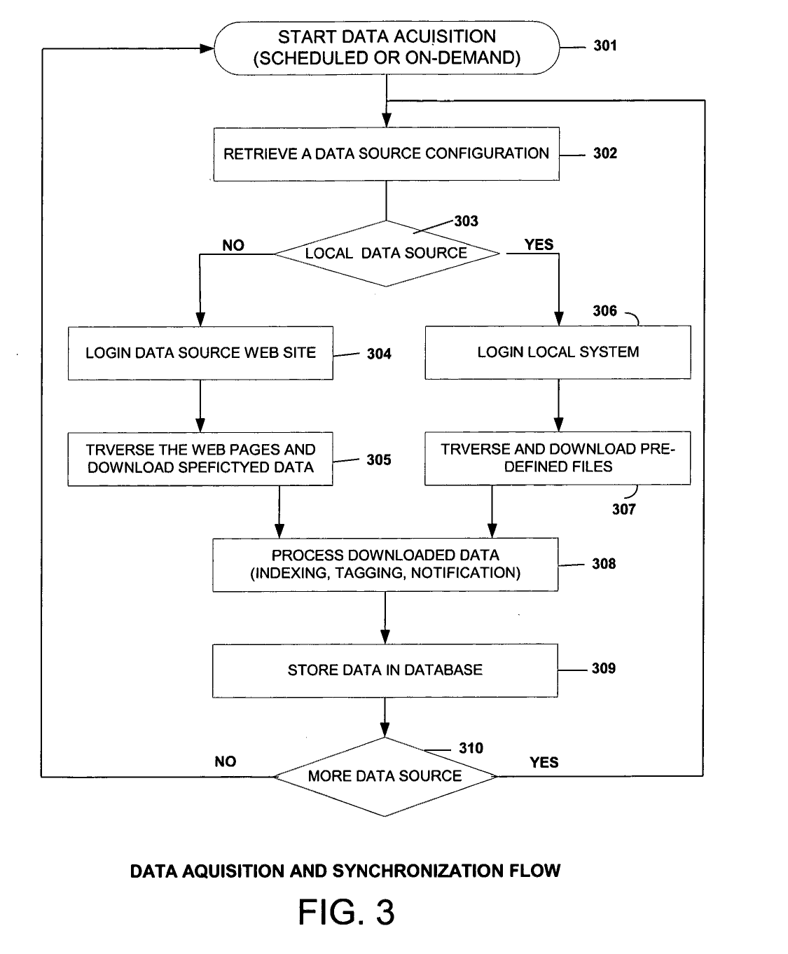

Referring now to FIG. 3, which illustrates the flow for data acquisition and synchronization. As show in block 301, data acquisition and synchronization can be triggered in two ways, a pre-defined periodical schedule, every minute for example, or on demand by a user request. Configurations of data sources from where data is acquired are stored in the database 207 in FIG. 2. The configuration of a data source includes web uniformed resource locator (URL) or server address, login credential (user name and password) and a list of contents (web pages or documents) to be retrieved. If a data source is a local personal computing device, the configuration specifies files to be synced. Configuration of data sources also contains data source name, category and data source type (local devices or remote public cloud). For example, the data source configuration for an email account include email server type (IMAP or POP3), server internet protocol (IP) address and port, security protocols (SSL or HTTPS), user name, password. The configuration for a social network would include web URL, user name and password for login, list of contents (news feed and blogs) to be downloaded. Once data acquisition is triggered, the data acquisition module 205 in FIG. 2 collects data by iterating over configurations for all data sources stored in the database. Block 302 loads the configuration of a data source from the database. Checking is performed by block 303 to find out whether data source is defined as local or remote. Block 304 logins in the remote server using credential in the configuration. Then contents specified in the configuration are downloaded to iCloud.

In one embodiment, Block 304 is implemented as a personal search engine that looks for only personal data/content relevant to a particular user over the internet public cloud. Since the search engine is triggered in a periodically, it does not only search the content origin information such as title, format, property, summary and author, but also tracks user operations on the data/content every time they open/read it. The tracking information includes user's action on the data, such as highlighting, marking up, commenting, notes, updating the content property and summary. Therefore, the data downloaded includes the original contents (web pages, files and documents), metadata (title, property, summary and author) as well as tracking information on the data. Similarly, block 305 and 306 logins in the local system and synchronizes pre-defined files to iCloud.

Block 308 processes data by creating index and tags based on its metadata and properties as well as the tracking information. Index and tagging using semantic text extraction and personalization method such as highlighting, comments and markups to extract key words from documents in various formats including Portable Document Format (pdf), Microsoft Word, html and text documents. The key words can be extract from the fields of “Overview”, “Facts”, “Summary” and “Keywords” of the document as well as “Properties” where you can see the original source. Lastly, the data is stored in the database for future use by block 308. The acquisition process then moves to next data source and it ends when all data sources are processed.

One aspect of present invention includes sending out notification to the user if the searching result meets the criteria specified in the configuration. One application of such functionality can be used in automatically searching products interested by the user over on-line vendors. When a product interested by the user is available and the price is under a pre-defined value, a notification will be sent to the user. This enables the user with an automatic way for finding the best deal over various on-line vendors. In one particular embodiment, for an e-commerce web site, additional to the URL, login credential and content (such as purchase transaction history) to be downloaded, the data source configuration can also include a list of products and corresponding target prices that the user is interested in. If the data downloaded from the online vendor contains a product available under the price specified in the configuration, a notification, such as email or text message, will be sent to the user in block 308. This feature effectively eliminated time-consuming manual web searching effort in order to find a product within the user's budget.

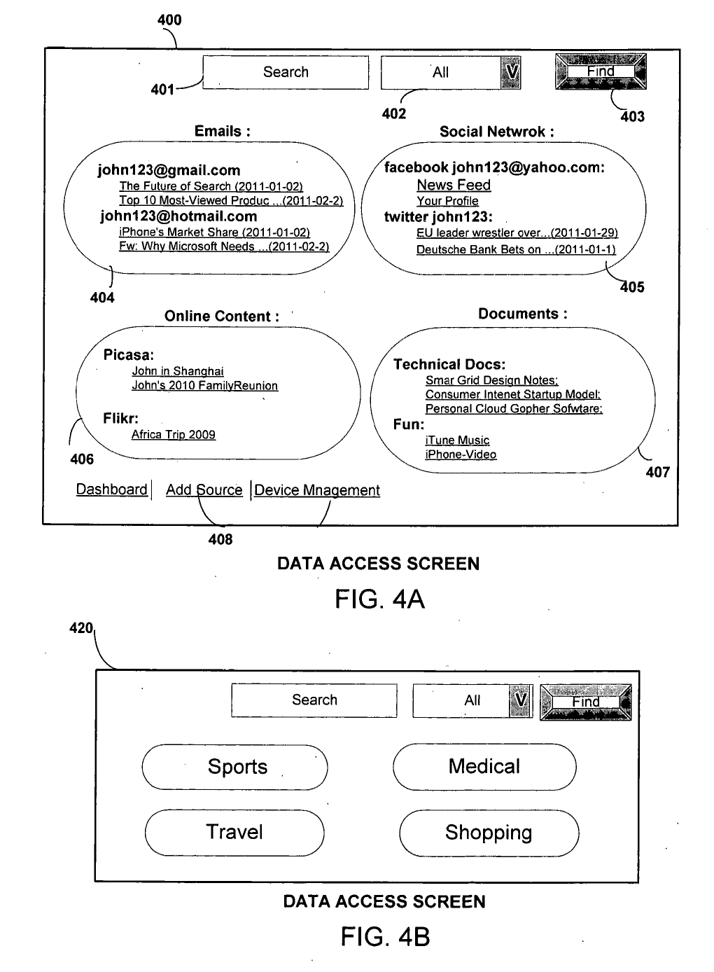

FIG. 4A shows a mock-up graphic user interface (GUI) screen 400 for use to access data stored in iCloud from a client device. After a user logging in iCloud from a client device, personal data collected from public internet is displayed based on the data categories, as shown in FIG. 4A. Display window 404 shows the subject lines of the emails collected from various email accounts owned by the user. Each subject line is a link for jumping to the full email body upon clicking on it. Window 405 displays contents from social networks. The contents include the user's own posts, blogs as well as the news and messages from connected friends. Data downloaded from online content (photos and videos) sharing web sites can be accessed from window 406. At the top of the screen, searching based on keywords can be executed by typing in words in box 401 and clicking on “find” button 403. Keywords typed in box 401 is used for finding matches in indices, tags and metadata of all data stored in the database. The contents with matching keywords in its index, tags and metadata will be displayed. The result of searching can also be sorted by properties, such as subject and date of the contents. The searching can also be narrowed or limited to a certain category by specifying the category in pull down menu 402. If ‘all’ is chosen in 402, contents in all categories are searched for the keyword specified in box 401.

Device Management 409 provides features for manage the iCloud system itself, such as monitoring system performance, rebooting or powering on and off the system, software upgrading and installing a new application. Device management is usually only available for the owner or “administrator” of the icloud.

Device management also include content sharing functionality which allows user's friends and family members to access iCloud. Friends and family members are classified into different groups and each group may have different permissions on what data content can be accessed. The data access permission based user group enables a flexible and secured personal data sharing capability which leads to powerful collaboration and partnership. Sharing can be allowed to a specific piece of information from one data source. For example, a friend can be granted to access a particular mail or document. In the case of sharing is permitted to a category from multiple data sources, a friend can access all the contents downloaded from all data sources in the category.

Furthermore, the user can also construct an information package for sharing by including content pieces or by specifying topic with keywords and iCloud will aggregate all the related information to form the package. For example, health records package can be constructed to contains all the information related to the user's matched “health record”. The user then notifies other parties that a package is ready for accessing by sending the email with the links. In this case, different access methods can be provided for sharing an information package. In “view only” mode, the receiving party can only view the content from the link one by one. The receiving party can also be allowed to download all the content and store at their local system in “download enabled” mode. In this way, iCloud users can share what they want, with whom they want and the content is always under user's full control.

There are multiple perspectives in which the content in iCloud can be displayed. For example, as shown in FIG. 4A, the information can be characterized by the format, such as email, photos, text documents or social network content. However, FIG. 4B shows information based on themes, such as sports, travel, medical information and shopping transactions.

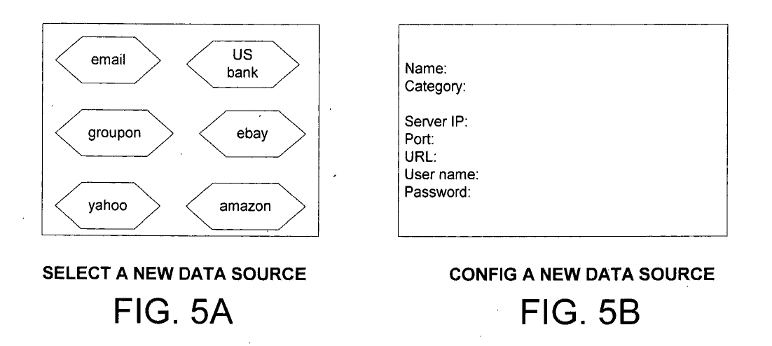

User can add a new data source by invoking “Add Source” 408. Screen showed in FIG. 5A displays all the supported data sources that are not currently in the list of data collecting. After user pick a new data source, the configuration of the data source need to be input by the user in screen shown in FIG. 5B, in which use need to specify the metadata (name and category) as well as access information (URL and credentials).

### Conclusion

Present invention provides a user to build a Personal Cloud focusing on individual's data, information and interests, regardless where the data are coming from and what are the data format being. Therefore, a user can access the data by himself/herself or share among friends and families over a trusted personal social cloud at anytime, from anywhere and on any devices in a secured, scalable and affordable way.

What is claimed is:

1. A method for aggregating, managing and sharing personal data, performed by a computing device, comprising:
collecting personal data from plurality of distributed data sources based on configuration of each data source, wherein the data sources including email servers, social network web sites, e-commerce web sites and local computing devices;
classifying, tagging and indexing the personal data and storing the personal data in a private data storage device;
responding data access requests from a client, wherein the client is internet browser or client program running on a computing device; and
generating profile data that conforms a specific data model by searching and analyzing the personal data stored in the data storage device.

2. The method of claim 1, wherein the personal data stored includes the content, metadata and tracking information, wherein the content includes documents, files or web pages, metadata includes title, property, summary and author, and tracking information includes history of user actions performed on the contents and metadata.

3. The method of claim 2, wherein indexing and tagging are based keywords extracted from the content, metadata and tracking information.

4. The method of claim 1, further comprising:
constructing an information package containing a subset of all personal data stored the data storage device, wherein the information package is shared by other parties based on access permission.

5. The method of claim 1, further comprising:
sending out notification when data collected meets the pre-defined criteria in the data source configuration.

6. The method of claim 1, further comprising:
generating profile data that conforms to a data model and submitting the profile data to a pre-defined online service provider or organization.

7. The method of claim 6, further comprising:
downloading and installing a third party software developed by on-line service provider.

8. The method of claim 7, wherein the service provider is e-commence vendor and the application retrieves commercial advisements based on user profile data.

9. A personal data management system comprising:
a processor;
a database; and
a computer-readable storage medium containing instructions, that when executed by the processor, cause the processor to perform:
searching and downloading personal data from internet, wherein the personal data includes emails stored in a plurality of email accounts, personal profiles, posts, photos and videos stored in a plurality of social network web sites, transaction history stored in a plurality of online vendors, and financial data stored in a plurality of financial institutions;
synchronizing files from personal computer devices, wherein computing devices are personal laptop, desktop, tablet and smart phones;
processing downloaded data by indexing and tagging and storing the data in the database;

10. The system of claim 9, wherein the instructions for searching is based on data source configurations including URL or server IP address and port, login credential and list of contents to be downloaded.

11. The system of claim 9, wherein the computer-readable storage medium also includes instructions for sending out notification if the download data satisfies the notification criteria.

12. The system of claim 11, wherein, the notification criteria includes products and prices the user is interested in for purchasing from on-line vendors.

13. The system of claim 9, wherein the computer-readable storage medium also includes instructions for system performance monitoring, software upgrading and new application software installation.

14. The system of claim 9, wherein the computer-readable storage medium also includes instructions for data mining and modeling over personal data in the database and generating user profile data, wherein the user profiles are sending to a plurality of receivers.

15. The system of claim 14, wherein the computer-readable storage medium also includes instructions for downloading and installing a third party application from an online service provider, wherein the online service provider is a e-commence vendor and the application retrieves commercial advisements from the vendor based on the profile data.

16. The system of claim 9, wherein the computer-readable storage medium also includes instructions for updating data sources by adding a new source, modifying or deleting an existing data source.

17. The system of claim 9, wherein the computer-readable storage medium also includes instructions for constructing an information package containing a subset of all personal data stored the database, wherein the information package is shared by other parties based on access permission.

18. The system of claim 9, wherein the computer-readable storage medium also includes instructions for triggering searching and synchronization based on a periodic scheduler or upon user request.
